(19) United States
(12) Patent Application Publication
(10) Pub. No.: US 2013/0177294 A1
(43) Pub. Date: Jul. 11, 2013

(54) INTERACTIVE MEDIA CONTENT SUPPORTING MULTIPLE CAMERA VIEWS

(71) Applicant: ALEKSANDR KENNBERG, WATERLOO (CA)

(72) Inventor: ALEKSANDR KENNBERG, WATERLOO (CA)

(21) Appl. No.: 13/345,682

(22) Filed: Jan. 7, 2012

(51) Int. Cl. H04N 9/80

(52) U.S. Cl. 386/241; 386/239; 386/E09.011

(57) ABSTRACT

A video file is created from a plurality of video segments according to one or more predefined parameters. Each video segment corresponds to a different camera view of a common temporal event. A computing device initiates playback of the video file within a first video segment corresponding to a first camera view. Responsive to a user input command, the computing device changes a playback position of the video file from a current frame number of the first video segment to a destination frame number of a second video segment of the video file. The destination frame number has a predefined relationship to the current frame number. The computing devices continues playback of the video file from the destination frame number within the second video segment corresponding to a second camera view to provide a different perspective of a subject captured in the plurality of video segments.

### BACKGROUND

Events such as sporting events and artistic performances are often captured by multiple cameras to provide viewers with different visual perspectives of the event. These multiple cameras may be arranged in a structured pattern or configuration relative to a particular focal point or region to provide viewers with a simulated rotational view about the focal point or region. The particular perspective that is presented to viewers at a given instance is typically controlled by the media organization or entity that is responsible for production of the media content. This form of central control of the media production process is typical of both live and pre-recorded media content.

### SUMMARY

A video file having a plurality of video segments is obtained by a computing device. Each video segment corresponds to a different camera view of a common temporal event. The computing device initiates playback of the video file within a first video segment corresponding to a first camera view of the common temporal event. Responsive to a user input command, the computing device changes a playback position of the video file from a current frame number of the first video segment to a destination frame number of a second video segment of the video file. The destination frame number has a predefined relationship to the current frame number. The computing devices continues playback of the video file from the destination frame number within the second video segment corresponding to a second camera view of the common temporal event. The second camera view provides a different perspective from the first camera view of a subject captured in the plurality of video segments.

The video file may be created by a computing device by obtaining the plurality of video segments and combining the plurality of video segments according to one or more predefined parameters to obtain the video file. The computing device stores the video file including the plurality of video segments at a storage system. The video file may be served to client computing devices from the storage system by a server device via a communications network.

Claimed subject matter, however, is not limited by this summary as other examples may be disclosed by the following written description and associated drawings.

### BRIEF DESCRIPTION OF DRAWINGS

FIG. 1 is a schematic diagram depicting an example video capture system.

FIG. 2 is a schematic diagram depicting an example video file having a plurality of video segments.

FIG. 3 is a schematic diagraph depicting an example video file with each video segment having a plurality of key-frames spaced apart and separated by one or more other frames of that video segment.

FIG. 4 is a schematic diagram depicting example transitions between two video segments within a video file.

FIG. 5 is a schematic diagram depicting an example transition between three video segments within a video file.

FIG. 6 is a schematic diagram depicting another example transition between three video segments within a video file.

FIGS. 7-9 are schematic diagrams depicting example graphical user interfaces for presenting a video file and for controlling playback of the video file among a plurality of video segments.

FIG. 10 is a flow diagram depicting an example method for playback of a video file having a plurality of video segments.

FIG. 11 is a flow diagram depicting an example method for combining a plurality of video segments to obtain a video file.

FIG. 12 is a schematic diagram depicting an example computing system.

FIG. 13 is a schematic diagram depicting an example graphical user interface for managing the creation of a video file having a plurality of video segments.

### DETAILED DESCRIPTION

An interactive platform for the creation and playback control of a video file is disclosed. The video file may have a plurality of video segments that correspond to different camera views of a common temporal event. A user may view a subject captured in these camera views from a number of different perspectives by navigating between corresponding video segments within the video file. Transitions between video segments may be performed according to a transitional process in which a playback position of a destination video segment has a predefined relationship to a current playback position of the video segment presented to the user. The transitional process may support time-registration of the video segments across transitions between camera views as well as support for the presentation of intermediate camera views spatially located between the current camera view and the destination camera view. These and other aspects of the interactive platform will be described in greater detail with reference to the following written description and associated drawings.

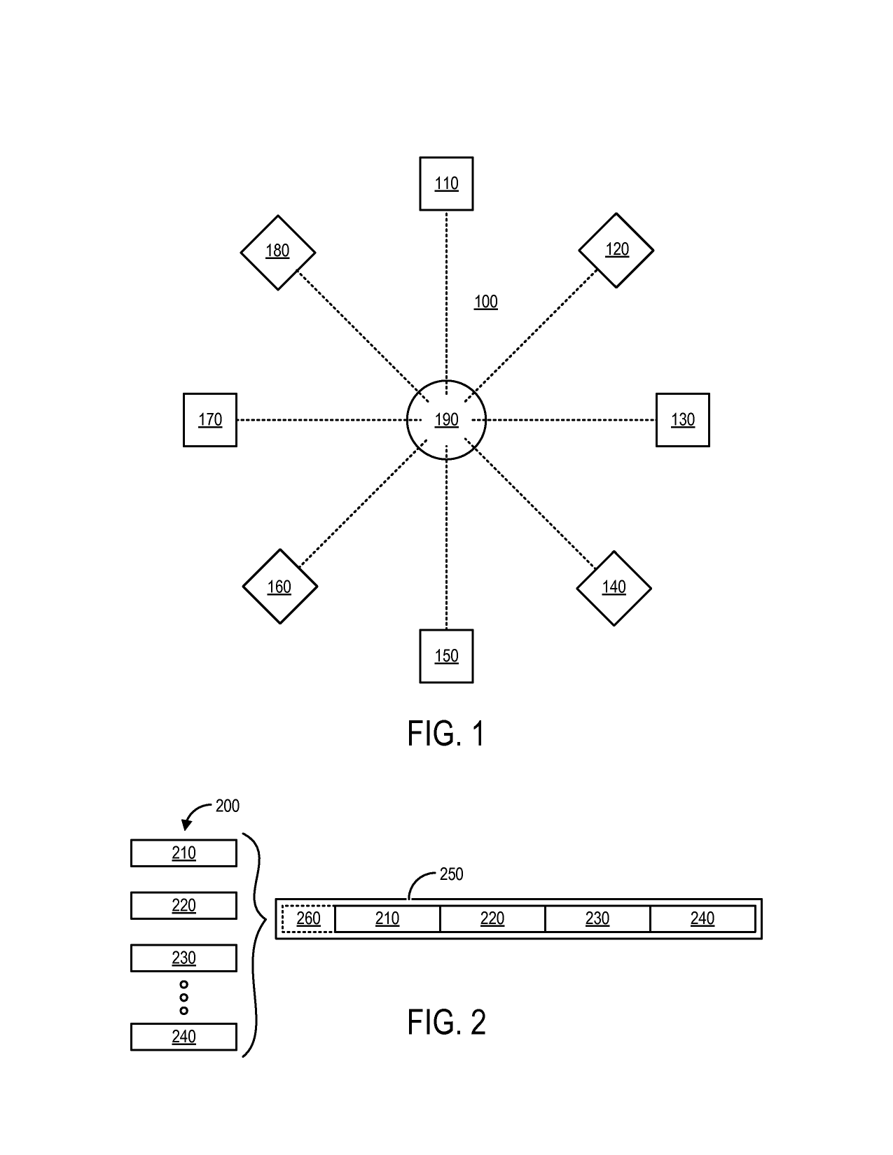

FIG. 1 is a schematic diagram depicting an example video capture system 100. Video capture system 100 includes a plurality of cameras (or other suitable optical sensors) for capturing respective video segments of a subject 190 from different camera views or perspectives. Subject 190 may include any physical object or group of objects of any size or shape located within a physical environment. The camera views of FIG. 1 are directed inward toward subject 190 in this particular example. However, one or more of the camera views of video capture system 100 may be directed outward from subject 190 in other examples.

Video capture system 100 may include any suitable number camera views provided by respective cameras located at any suitable position and/or orientation relative to a subject. FIG. 1 depicts a non-limiting example of video capture system 100 having eight cameras surrounding subject 190. However, video capture system 100 may include a different number of cameras, such as 2, 3, 4 or more cameras, 10 or more cameras, 20 or more cameras, 100 or more cameras, etc.

In at least some implementations, each camera view provided by a respective camera of video capture system 100 may be spaced apart from one or more of the other camera views at intervals relative to subject 190. As one example, at least some of the camera views may be spaced apart from each other at regular intervals. For example, the eight camera views depicted in FIG. 1 are spaced apart from each other by 45 degrees along a circle, ellipse, or arc surrounding subject 190. As another example, video capture system 100 may include only four cameras providing four camera views surrounding subject 190 (e.g., cameras 110, 130, 150, and 170). As yet another example, video capture system 100 may include only five cameras partially surrounding subject 190 (e.g., cameras 110, 120, 130, 140, and 150). In some implementations, at least some of the camera views may be spaced apart from each other at irregular intervals. For example, video capture system 100 may include only video cameras 110, 120, and 160.

While FIG. 1 depicts a number of cameras capturing a subject from a number of different perspectives within a two-dimensional plane, it will be understood that video capture system 100 may include cameras positioned in three-dimensional space relative to subject 190. For example, camera 120 may be located at a different altitude and/or orientation from camera 110 relative to the two-dimensional plane of FIG. 1. As another example, video capture system 100 may include one or more cameras located above or below subject 190 relative to the two-dimensional plane of FIG. 1. The two-dimensional plane of FIG. 1 may include a vertical plane, horizontal plane, or angled plane relative to the subject. For example, a circle or arc of cameras may be positioned within a vertical plane (e.g., around a moving human subject such as a swimmer). In some implementations, an arrangement of cameras may form multiple sets (e.g., a circle or arc) located at different horizontal or vertical planes. Cameras may be stationary, may move relative to the subject, or may move with the subject or while tracking the subject. Cameras may be actively controlled by a human operator or may be controlled by an automated control system. For example, the location of the camera may be moved over time to stay focused on the subject or to meet other requirements, such as maintaining the subject in full frame of the camera.

FIG. 2 is a schematic diagram depicting an example video file 250 having a plurality of video segments 210, 220, 230, and 240. Each of these video segments may correspond to a different camera view of a common temporal event 200. For example, video segment 210 may correspond to a camera view of camera 110 of FIG. 1 capturing subject 190 from a first perspective, and video segment 220 may correspond to a camera view of camera 120 of FIG. 1 capturing subject 190 from a second perspective over the same time period. Video file 250 may include any suitable number of video segments that correspond to different camera views of a common temporal event. For example, video file 250 may include 2, 3, 4 or more video segments, 10 or more video segments, 20 or more video segments, 100 or more video segments, etc. of a common temporal event.

Additionally, video file 250 may include one or more video segments that do not correspond to the common temporal event. For example, video file 250 may include a pre-roll video segment 260. Pre-roll video segment 260 may include, for example, an advertisement and/or an introduction of video file 250.

In FIG. 2, the video segments of video file 250 are depicted as having a linear relationship to each other. This linear relationship may graphically depict a playback order of the video segments within the video file (e.g., from left to right) and/or may graphical depict a data structure of the video file with respect to the individual video segments. The playback order of the video segments and data structure of the video file will be subsequently described in greater detail.

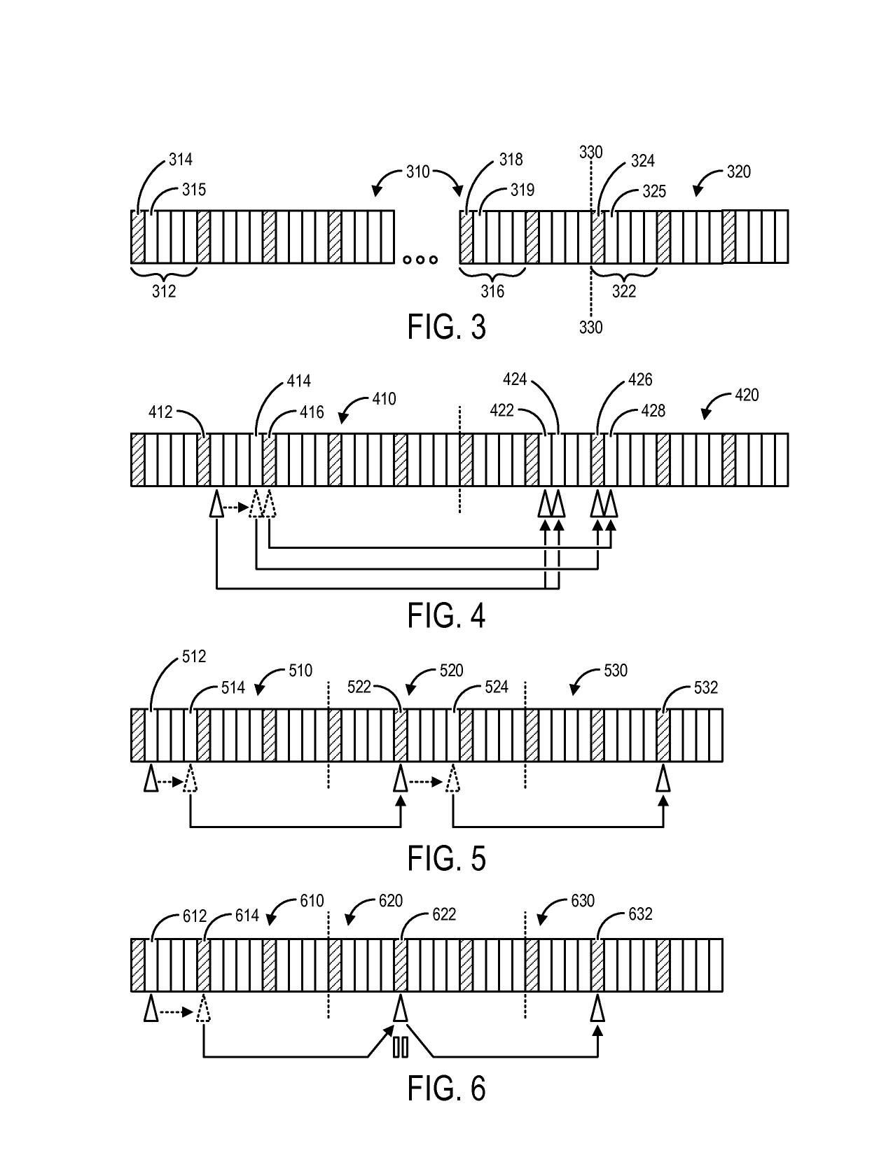

FIG. 3 is a schematic diagraph depicting an example video file with each video segment having a plurality of key-frames spaced apart and separated by one or more other frames (e.g., non-key frames) of that video segment. A key-frame may refer to a frame that includes the information used by a media or browser application program (e.g., a media player) to render the video content. Non-key frames, by contrast, may include less information or different information than a key-frame, such as the differences between the non-key frame and the neighboring frame(s) or key-frame(s). Accordingly, some media or browser application programs may only enable a user to seek between key-frames, and may not support seeking between or among non-key frames.

Each frame may correspond to an individual image of a video file that includes a series of images that are ordered in time. Each of the video segments described herein may have any suitable frame rate (e.g., 10, 30, 60, 120 frames per second). Individual video segments of a video file may have the same or different frame rate as compared to other video segments of the video file. Frame rates may vary within some video segments. For example, a video segment may include a first portion that has a first frame rate that is followed by a second portion that has a second frame rate that is different than the first frame rate. Frame rate may be varied across some video segments responsive to or to account for relative motion of a subject captured by the camera view of the video segment. For example, frame rate may be increased for portions of the video segment where the subject is moving at a higher speed.

Referring to FIG. 3, a first video segment 310 includes a frame set 312 that includes a key-frame 314 that is followed by a number of other frames (i.e., non-key frames), including example frame 315. Any suitable ratio may be used for the number of key-frames to non-key frames. For example, in FIG. 3, there is 1:4 relationship between key-frames and non-key frames such that first video segment 310 includes a key-frame located at every 5th frame. However, key-frames may be located at every 10th frame, 20th frame, or other suitable frame number in other examples. FIG. 3 further depicts first video segment 310 including another example frame set 316 prior to an interface 330 with a second video segment 320. Frame set 316 includes a key-frame 318 that is again followed by four other frames (i.e., non-key frames), including example frame 319. First video segment 310 is depicted in two parts in FIG. 3 to denote that video segments may have any suitable length or number of frames, including tens, hundreds, thousands, millions, or more frames.

Second video segment 320 includes a frame set 322 that includes a key-frame 324 that is followed by a number of other frames (i.e., non-key frames), including example frame 325. Accordingly, FIG. 3 depicts an example where first video segment 310 and second video segment 320 have the same ratio of key-frames to non-key frames. In at least some implementations, video segments may include different ratios of key-frames to non-key frames. For example, second video segment 320 may alternatively include key-frames spaced every 10th frame while first video segment 310 includes key-frames spaced every 5th frame.

FIG. 3 further depicts each video segment beginning with a key-frame. For example, first video segment 310 begins with key-frame 314, and second video segment 320 begins after interface 330 with key-frame 324. In at least some implementations, at least some of the video segments of the video file (e.g., first video segment 310 and second video segment 320) may have an equal number of frames (e.g., an equal number of key-frames and an equal number of non-key frames).

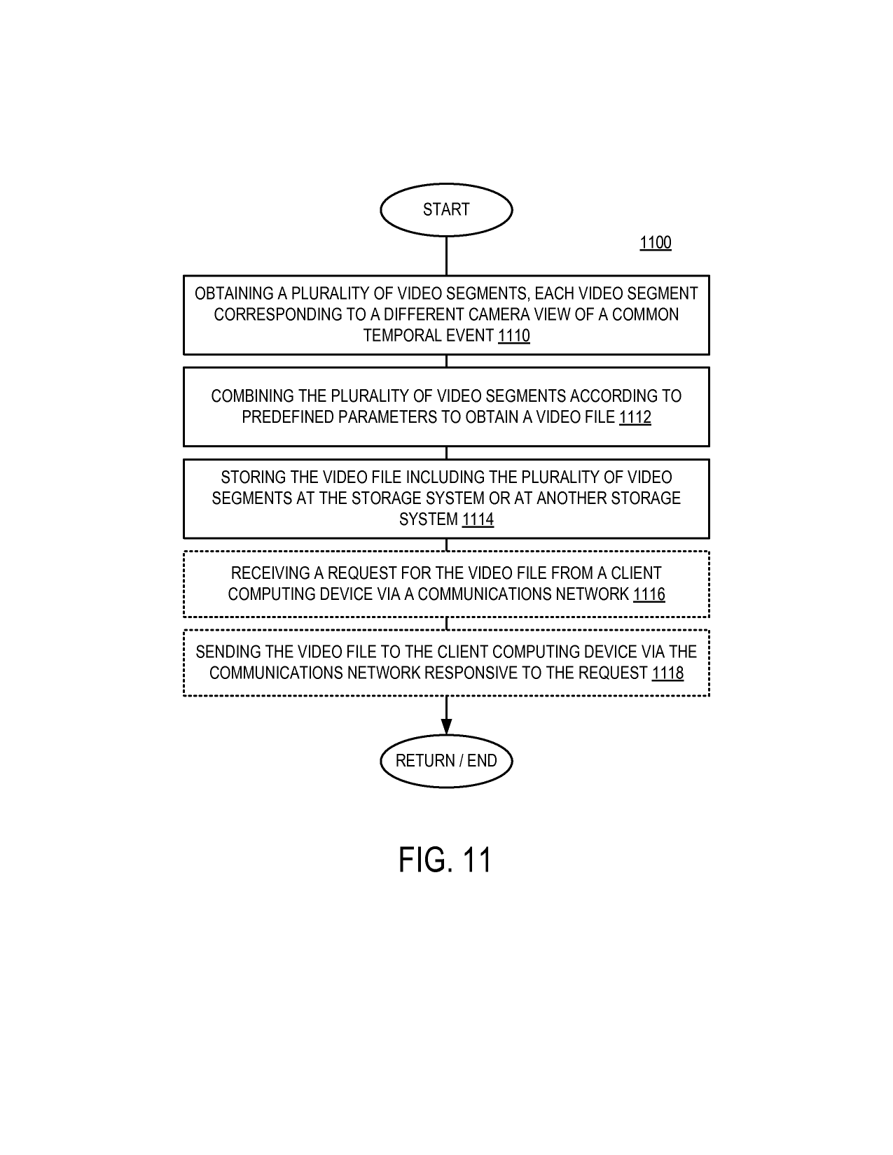

In at least some implementations, each key-frame of a first video segment may be in time registration (e.g., capturing the subject at the same or substantially the same instance) with at least one corresponding key-frame of a second video segment with respect to the common temporal event. For example, key-frame 314 of first video segment 310 may be in time registration with key-frame 324 of second video segment 320. Similarly, each frame of a first video segment may be in time registration with at least one corresponding frame of a second video segment. For example, frame 315 of first video segment 310 may be in time registration with frame 325 of second video segment 320. Time registration will be described in greater detail with reference to FIG. 11. Briefly, however, it will be understood that any suitable technique may be used to obtain time registration between two or more video segments. As one example, an audio component of the video segments may be used to align a video component of the video segments with respect to audio information (e.g., an audible event or series of events) that is common to each video segment.

In at least some implementations, key-frames and/or non-key frames of a video segment may not be in time registration with key-frames and/or non-key frames of one or more other video segments. As one example, a time registration of key-frame 324 of second video segment 320 may be offset (e.g., time-shifted) from key-frame 314 of first video segment 310 by a time offset value. This time offset value may be less than an entire frame in duration or may correspond to one or more discrete frames in duration. For example, key-frame 324 of second video segment 320 may be in time registration with non-key frame 315 of first video segment 310. As another example, key-frame 318 may be time-shifted by one half of the frame rate in duration so that key-frame 318 partially overlaps in time with key-frame 314 and non-key frame 315 of first video segment 310. As yet another example, key-frames of a second video segment may be in time registration with key-frames of a first video segment, while non-key frames of the second video segment are not in time registration with non-key frames of the first video segment. For example, second video segment 320 may include a different number of non-key frames per frame set 322 (e.g., non-key frames having a longer or shorter duration) than non-key frames per frame set 312. However, the total length of time of frame set 312 may be equal to the total length of time of frame set 322 to provide time registration of key-frames across some or all of the video segments. Offsets in key-frames and/or non-key frames of a video segment may be in either time direction relative to key-frames and/or non-key frames of other video segments.

FIG. 4 is a schematic diagram depicting example transitions between two video segments within a video file. For example, FIG. 4 depicts a video file including a first video segment 410 having a number of key-frames (e.g., 412, 416, etc.) and a number of non-key frames (e.g., 413, 414, etc.), and a second video segment 420 having a number of key-frames (e.g., 426, etc.) and a number of non-key frames (e.g., 422, 424, 428, etc.).

Playback may be initiated within a first video segment. A transition between video segments of the video file may include changing a playback position of the video file from a current frame number of first video segment 410 to a destination frame number of second video segment 420 of the video file. The transition may be initiated responsive to a user input command. Playback of the video file may be continued from the destination frame number within the second video segment. The destination frame number may have a predefined relationship to the current frame number as will be subsequently described in greater detail.

As one example, the current frame number may correspond to frame 413 and the destination frame number may correspond to frame 422. The predefined relationship may define the same frame number relative to a beginning frame of each video segment, for example, if each video segment has the same number of frames and frame rate. Alternatively or additionally, the current frame number (e.g., frame 413) of first video segment 410 may be in time registration with the destination frame number (e.g., frame 422) of second video segment 420 with respect to a common temporal event. This type of transition may be used to maintain the same frame number and/or same time registration across two video segments.

As another example, the current frame number may correspond to frame 413 and the destination frame number may correspond to frame 424. Here, the predefined relationship may define the destination frame number (e.g., frame 424) as being immediately subsequent to a frame number (e.g., frame 422) of second video segment 420 that is in time registration with the current frame number (e.g., frame 413) of first video segment 410 with respect to the common temporal event. This type of transition may be used to maintain a time ordered sequence of frames across two video segments.

As yet another example, transitions may include a delay imposed in response to a user input command before changing the playback position of the video file. Here, playback of the video file may be continued within the first video segment until the current frame reaches a frame having a predefined position and/or frame type (e.g., key-frame or non-key frame) within the first video segment. The frame of the first video segment may include the next key-frame or a non-key frame preceding the next key-frame. For example, responsive to a user input command during playback of frame 413, playback may continue from frame 413 to 414 before the playback position is changed from first video segment 410 to a destination frame of second video segment 420 (e.g., frame 426 or frame 428). Here, the frame having the predefined position relative to a frame of the first video segment may be defined as a key-frame (e.g., key-frame 426) or a frame subsequent to a key-frame (e.g., non-key frame 428). This type of transition enables coordination among two video segments with respect to the key-frames. For example, if the key-frames of the video segments are in time registration with each other, but the non-key frames are not in time registration with each other, then transitions between video segments with respect to the key-frames may be used to maintain the same frame number and/or same time registration across the two video segments.

FIG. 5 is a schematic diagram depicting example transitions between three video segments (e.g., video segments 510, 520, and 530) within a video file. In this example, a second video segment 520 provides an intermediate camera view for smoothing the appearance of the transition between two other camera views. A first transition in FIG. 5 between first video segment 510 and second video segment 520 is delayed (e.g., from a current frame 512) responsive to a user input command until the playback position reaches a non-key frame (e.g., frame 514) preceding a key-frame. The destination frame of the first transition corresponds to a key-frame (e.g., frame 522). A second transition in FIG. 5 between second video segment 520 and third video segment 530 is again delayed (e.g., from frame 522) until the playback position reaches a non-key frame (e.g., frame 524) preceding a key-frame. The destination frame of the second transition also corresponds to a key-frame (e.g., frame 532).

In at least some implementations, the first and second transitions of FIG. 5 may correspond to a common transitional process that is performed responsive to a single user input command or set of user input commands. For example, second video segment 520 may correspond to a camera that is located between a camera that corresponds to first video segment 510 and a camera that corresponds to third video segment 530 to provide an intermediate camera view across a transition between first video segment 510 and third video segment 530. Any suitable number of intermediate camera views may be provided between transitions between video segments. For example, if transitioning from camera 110 to camera 150 of FIG. 1, video segments may be presented during the transition for intermediate cameras 120, 130, and 140, or intermediate cameras 180, 170, and 160.

FIG. 6 is a schematic diagram depicting another example transition between three video segments (e.g., 610, 620, and 630) within a video file. In this example, a user control input is initiated to transition from first video segment 610 to third video segment 630, while second video segment 620 again takes the form of an intermediate camera view. Here, the transition from first video segment 610 to second video segment 620 is delayed responsive to a user control input received during playback of non-key frame 612 until the playback position of key-frame 614 is reached. The transition is performed in this example, from key-frame 614 of first video segment 610 to key-frame 622 of second video segment 620. Furthermore, in this example, playback of second video segment 620 is paused (e.g., at key-frame 622) for a period of time before the transition is continued to key-frame 632 of third video segment 630. Playback during a transition may be paused for any suitable period of time or may not be paused in at least some implementations. Pausing playback during a transition may increase the user's ability to understand or comprehend the transition between camera views and/or may be used to smooth the appearance of the transition.

FIGS. 7-9 are schematic diagrams depicting example graphical user interfaces (GUI)s for presenting a video file and for controlling playback of the video file among a plurality of video segments. These GUIs may be presented via a graphical display device of a computing device or computing system, and may include a variety of control elements and/or graphical indicators. At least some of these control elements and/or graphical indicators may be presented over a portion of the visual aspects (e.g., a video component) of the video file that are presented to the user. Alternatively or additionally, at least some of these control elements and/or graphical indicators may be presented along side the visual aspects of the video file so as to not obscure the visual aspects that are presented to the user.

FIG. 7 depicts a GUI 700 defining a video presentation region where visual aspects of a video file may be presented. GUI 700 may further include one or more control elements that are operable by a user to control playback of the video file. Non-limiting examples of these control elements may include a play control element to initiate playback of the video file, a pause control element to pause playback of the video file, a forward seek control element to change a playback position of the video file in a forward direction, a reverse seek control element to change a playback position of the video file in a reverse direction, among other suitable control elements. For example, FIG. 7 depicts GUI 700 as including a scrub bar (e.g.,. a video file progress bar) having a playback position indicator 712 that travels along the scrub bar to indicate a current playback position of the video file.

In at least some implementations, a user may change a playback position of the video file, for example, by dragging the playback position indicator 712 (e.g., also a graphical control element) along the scrub bar in a forward or reverse direction. The scrub bar may graphically indicate a plurality of individual video segments of the video file. For example, a graphical indicator 714 may correspond to previously described video segment 210 of FIG. 2, and a graphical indicator 710 may correspond to previously described video segment 240 of FIG. 2. A user may view a subject captured in the video segments from a different perspective or camera view, for example, by directing a user input at playback position indicator 712 to change the playback position of the video file from the current playback position within the video segment indicated by graphical indicator 714 to a destination playback position within the video segment indicated by graphical indicator 710.

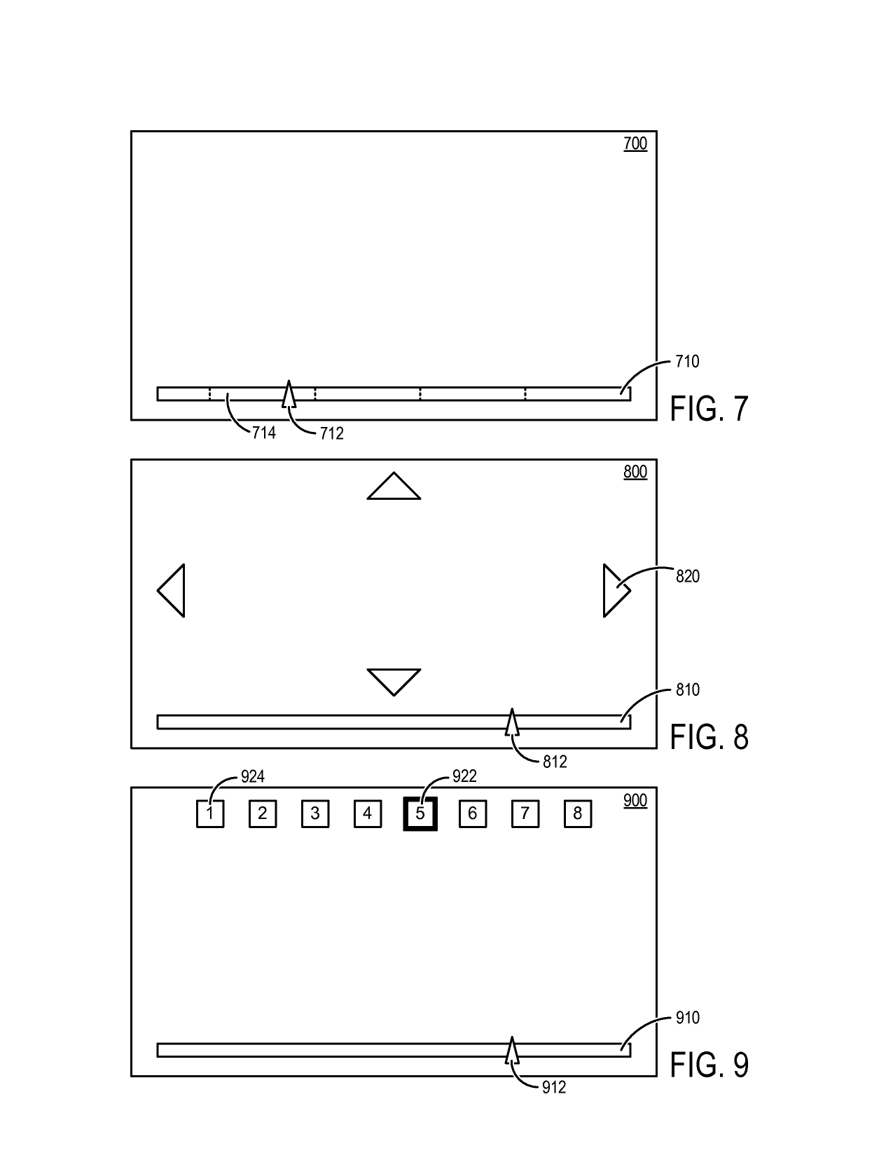

FIG. 8 depicts a GUI 800 defining another video presentation region where visual aspects of a video file may be presented. GUI 800 may also include one or more control elements that are operable by a user to control playback of the video file. For example, FIG. 8 depicts GUI 800 as including a scrub bar graphically indicated at 810 having a playback position indicator 812 that travels along the scrub bar to indicate a current playback position. In contrast to GUI 700, the scrub bar graphically indicated at 810 may represent a length of only one video segment of the plurality of video segments of a common temporal event. For example, playback position indicator 812 may indicate the current playback position within a particular video segment of the plurality of video segments of the common temporal event. Accordingly, the length of the scrub bar graphically indicated at 810 may represent the length of the common temporal event (e.g., as captured by an individual video segment) rather than the length of the entire video file, which may include a plurality of video segments of the common temporal event. In this way, GUI 800 does not graphically expose the existence of multiple video segments to the user. Hence, playback of the video file may end once a last frame of any video segment of that video file is reached. Accordingly, the current playback position of the selected video segment may be common to (e.g., in time registration with) two or more of the video segments of the video file even as the camera view is varied.

In at least some implementations, a user may change a playback position within an individual video segment, for example, by dragging the playback position indicator 812 along the scrub bar graphically indicated at 810 in a forward or reverse direction. GUI 800 may further include one or more graphical control elements for changing camera views within a video segment. For example, GUI 800 includes a graphical control element 820. A user may direct a user input at graphical control element 820 to change a playback position of the video file from the current playback position within a first video segment to a destination playback position (e.g., the same or similar corresponding playback position relative to the common temporal event) of a second video segment.

GUI 800 is depicted as including a left arrow, a right arrow (e.g., graphical control element 820), an up arrow, and a down arrow which may enable a user to spatially navigate among a plurality of cameras or camera views positioned at different locations and/or orientations relative to a subject. A user may view a subject from a different perspective or camera view captured, for example, by a camera located to the right of the currently presented camera view by directing a user input at the right arrow (e.g., graphical control element 820). As another example, a user may view the subject from a different perspective or camera view captured, for example, by a camera located at a higher elevation relative to the current camera view by directing a user input at the up arrow.

FIG. 9 depicts a GUI 900 defining another video presentation region where visual aspects of a video file may be presented. GUI 900 may also include one or more control elements that are operable by a user to control playback of the video file. GUI 900 may include a scrub bar 910 and playback position indicator 912 that are similar to those previously described for GUI 800. Alternatively, GUI 900 may include a scrub bar that includes graphical indications of individual video segments as previously described for GUI 700. FIG. 9 further depicts how GUI 900 may include a number of graphical control elements that correspond to respective cameras and/or camera views that are available for selection by the user. For example, GUI 900 has 8 graphical control elements, which may correspond to the eight cameras of FIG. 1.

Graphical control element 922 may have a different appearance from other graphical control elements to indicate to the user that the current playback position of the video file is within a video segment that corresponds to that camera or camera view (e.g., camera or camera view “5”). A user may view a subject from a different perspective or camera view captured, for example, by a camera (e.g., camera “1”) by directing a user input at graphical control element 924.

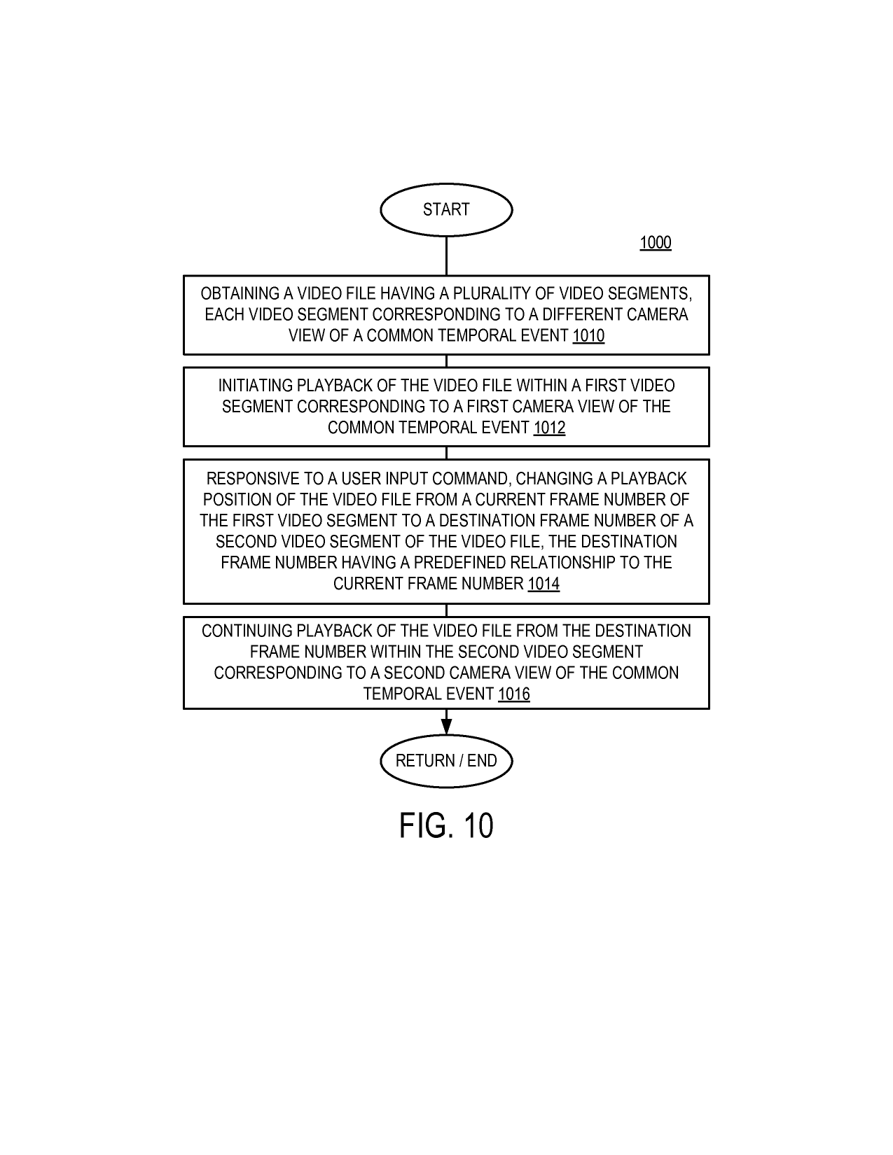

FIG. 10 is a flow diagram depicting an example method 1000 for playback of a video file having a plurality of video segments. Method 1000 may be performed by a computing device. For example, method 1000 may be performed by a processor of the computing device executing instructions that are held in a storage device that is accessible to the processor. The computing device may take the form of a stand-alone computing device or a client computing device of a communications network operated by a user. Alternatively, the computing device may take the form of a server device that is configured to serve video files to a client computing device operated by a user via a communications network.

At 1010, the method may include obtaining a video file having a plurality of video segments. The video file may include or may be accompanied by audio information and/or metadata. At 1012, the method may include initiating playback of the video file within a first video segment corresponding to a first camera view of the common temporal event. At 1014, the method may include, responsive to a user input command, changing a playback position of the video file from a current frame number of the first video segment to a destination frame number of a second video segment of the video file.

It should be understood that the terms “first” video segment and “second” video segment as used herein do not necessarily denote the physical location or position of the video segment within the video file. For example, the first video segment may correspond to the Nth video segment of the video file, and the second video segment may correspond to the Nth minus one or more video segments, or to the Nth plus one or more video segments of the video file relative to the first video segment. Accordingly, the terms “first” and “second” may be used herein to distinguish the two video segments.

As previously described with reference to FIGS. 3-6, the destination frame number may have a predefined relationship to the current frame number. This predefined relationship may include a number of frames or a duration of time between the current frame and the destination frame. As one example, if each video segment is 1000 frames in length, the destination frame may be located by adding 1000 frames to the current frame to continue playback from the same frame within the destination video segment immediately following the current video segment. If the destination video segment is spaced apart from the current video segment by an intermediate video segment, then the destination frame may be located by adding 2000 frames to the current frame. If the destination video segment precedes the current video segment, then 1000 frames may be subtracted from the current frame to locate the destination frame. As another example, if each video segment has a time duration of 30 seconds, then 30 seconds of time may be added to the current playback position to continue playback from the same time location within the destination video segment immediately following the current video segment.

In at least some implementations, the destination frame may be selected so that it is as close to the current frame as possible while still occurring at the same or later absolute time relative to the current frame to provide a smooth transition between video segments. As one example, the predefined relationship may define the same frame number relative to a beginning frame of each video segment. As another example, the predefined relationship may define a different frame number relative to a beginning frame of each video segment, whereby the destination frame number is offset from the current frame number by a predefined number of frames. For example, the predefined relationship of the destination frame number to the current frame number may define the destination frame number as being immediately subsequent to a frame number of the second video segment that is in time registration (or out of time registration) with the current frame number of the first video segment with respect to the common temporal event.

At 1016, the method may include continuing playback of the video file from the destination frame number within the second video segment corresponding to a second camera view of the common temporal event to provide a different perspective of a subject captured in the plurality of video segments. As previously discussed, the method may further include delaying changing the playback position of the video file and continuing playback of the video file within the first video segment until the current frame reaches a frame having a predefined position relative to a key-frame of the first video segment.

Method 1000 may be applied to transitions between more than two video segments of a video file. For example, the method may further include, responsive to another user input command, changing a playback position of the video file from a current frame number of the second video segment to a destination frame number of a third video segment. The destination frame number of the third video segment may also have a predefined relationship to the current frame number of the second video segment.

The method may further include continuing playback of the video file from the destination frame number within the third video segment corresponding to a third camera view of the common temporal event. Here, the first camera view may be positioned closer to the second camera view than the third camera view. Alternatively or additionally, the second camera view may be positioned between the first camera view and the third camera view along an arc having a focal point that includes the subject captured in the plurality of video segments. Accordingly, the second video segment may provide one or more transitional frames between playback of the first video segment and the third video segment.

FIG. 11 is a flow diagram depicting an example method for combining a plurality of video segments to obtain a video file. Method 1100 may be performed by a computing device. For example, method 1100 may be performed by a processor of the computing device executing instructions that are held in a storage device that is accessible to the processor. The computing device may take the form of a stand-alone computing device operated or a client computing device of a communications network operated by a user. Alternatively, the computing device may take the form of a server device that is configured to receive input commands from a client computing device and/or serve video files to the client computing device via a communications network.

At 1110, the method may include obtaining a plurality of video segments. Each video segment may correspond to a different camera view of a common temporal event. At 1112, the method may include combining the plurality of video segments according to one or more predefined parameters to obtain a video file. As one example, the method at 1112 may include inserting a plurality of key-frame indicators into the video file. The plurality of key-frame indicators may designate a plurality of key-frames spaced apart among frames of each video segment. At least one key-frame of each video segment may correspond to a time event of the video segment that is shared with (e.g., in time registration with) corresponding key-frames of the other video segments of the video file. Time registration of video segments or key-frames within video segments may be achieved by detecting an audio event or audio information within an audio component that is common to each of the video segments. The method at 1112 may further include encoding the video file, for example, by application of a codec. In at least some implementations, the codec may be applied to create or otherwise designate key-frames and non-key frames within the video file or video segments.

At 1114, the method may include storing the video file including the plurality of video segments at a storage device or storage system. At 1116, the method may include receiving a request for the video file from a client computing device via a communications network. At 1118, the method may include sending the video file to the client device via the communications network responsive to the request. The video file may include or may be accompanied by audio information and/or metadata. The method at 1116 and 1118 may not be performed, for example, if the computing device performing method 1100 is the client computing device or a stand-alone computing device operated by a user. Alternatively, method 1100 may be performed by a client computing device at 1110, 1112, and 1114, and may be performed by a server device or server system at 1116 and 1118, for example, responsive to a request initiated by the client computing device.

In at least some implementations, the method at 1112 may further include obtaining a plurality of camera position and/or orientation indicators. Each camera position and/or orientation indicator may define a camera or camera view position and/or orientation for an individual video segment. The plurality of video segments may be combined by ordering the plurality of video segments within the video file based, at least in part, on the relative positioning of the camera or camera view position and/or orientation indicated by the plurality of camera position and/or orientation indicators. For example, if a number of cameras are arranged along a circle, ellipse, or arc surrounding or partially surrounding a subject, then the video segments corresponding to these cameras may be ordered within the video file according to the clockwise or counter-clockwise order of the cameras.

In at least some implementations, the method at 1112 may further include designating at least one frame in each video segment as a key-frame. Each key-frame may correspond to a shared time event (e.g., in time registration) across each video segment. Combining the plurality of video segments to obtain the video file may include concatenating the plurality of video segments with respect to the key-frames. For example, as previously described with reference to FIG. 3, a first frame of a video segment (e.g., second video segment 320) at an interface with another video segment (e.g., first video segment 310) may include or take the form of a key-frame. In at least implementations, the method may further include trimming one or more of the plurality of video segments to a common frame length before concatenating the plurality of video segments, including the one or more trimmed video segments. For example, some video segments may have a different frame length than other video segments before their combination to obtain the video file.

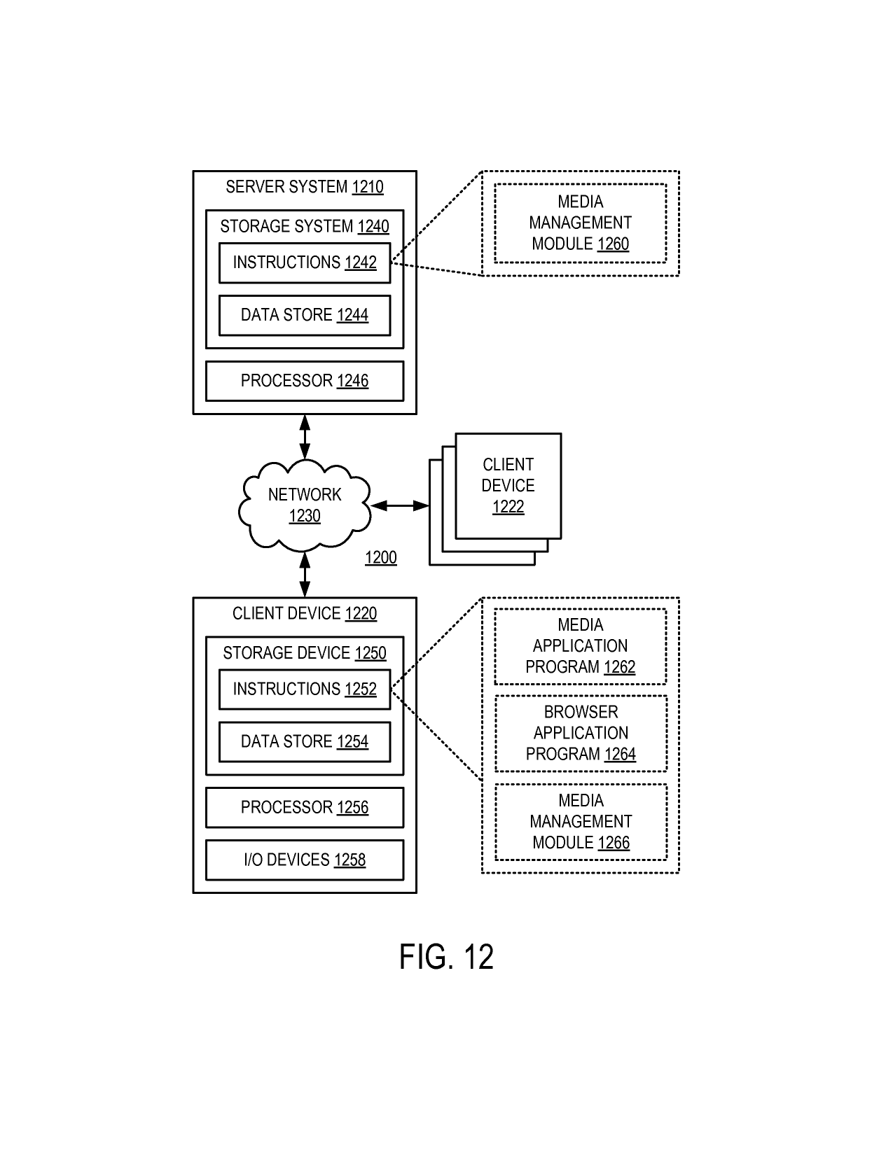

FIG. 12 is a schematic diagram depicting an example computing system 1200. Computing system 1200 may include a server system 1210 that communicates with one or more client devices via a communications network 1230. In FIG. 12, example client devices include client device 1220, 1222, etc. Communications network 1230 may include or take the form of the Internet or a portion thereof, an Intranet, a local area network (LAN), a personal area network, and/or other suitable communications network.

Server system 1210 may include one or more server devices. Two or more server devices may take the form of a distributed server system in some implementations. Accordingly, communications between two or more server devices may include communication via communications network 1230. Server system 1210 includes a storage system 1240 holding instructions 1242 and a data store 1244. Server system 1210 includes one or more processors (e.g., processor 1246) to execute instructions (e.g., instructions 1242). Instructions 1242 to may include or take the form of one or more application programs, an operating system, firmware, and/or other suitable instruction set. As a non-limiting example, instructions 1242 may include a media management module 1260. Media management module 1260 may be configured to perform one or more of the methods, functions, and/or operations described herein with respect to a server system or server device, including methods 1000 and 1100. For example, media management module 1260 may be configured to receive information from and transmit information to a GUI, such as GUI 1300 of FIG. 3 for managing the creation of a video file having a plurality of video segments. As one example, media management module 1260 may be configured to apply a codec to a group of video segments to obtain an encoded video file containing the group of video segments.

Client device 1220 is a non-limiting example of a client device. It will be understood that computing system 1200 may include any suitable number of client devices. Client device 1220 includes a storage system 1250 holding instructions 1252 and a data store 1254. Client device 1220 includes one or more processors (e.g., processor 1256) to execute instructions (e.g., instructions 1252). Instructions 1252 to may include or take the form of one or more application programs, an operating system, firmware, and/or other suitable instruction set. As a non-limiting example, instructions 1252 may include a media application program 1262, a browser application program 1264, and/or a media management module 1266. Media application program 1262, browser application program 1264, and/or media management module 1266 may be configured to perform one or more of the methods, functions, and/or operations described herein with respect to a client computing device or stand-alone computing device operated by a user, including methods 1000 and 1100.

Media application program 1262 may include or take the form of a general purpose media application program or a special purpose media application program that is specifically configured to present the video files described herein that include a plurality of video segments. In some implementations, a general purpose media application program may playback the video file disclosed herein and enable navigation within the video file without the need for specialized codecs or plugins (e.g., such as Flash). This media application program may be configured to identify the current video playback position of the video file and support the ability for the user to change the current playback position of the video file to change the camera view that is presented to the user. Browser application program 1264 may include or take the form of a general purpose web browser or a general purpose file browser that includes a media player function, or may include or take the form of a special purpose web browser or special purpose file browser that is specifically configured to present the video files described herein that include a plurality of video segments. Again, a general purpose browser program may, in some implementations, playback the video file disclosed herein and enable navigation within the video file without the need for specialized codecs or plugins. As one example, media application program 1262 and/or browser application program 1264 may be configured to present a GUI, such as GUIs 700, 800, and 900 of FIGS. 7-9. In at least some implementations, a general purpose media application program, web browser, or file browser may be adapted or converted to present these GUIs by their combination with a software plug-in or other suitable instruction set. Media application program 1262 and/or browser application program 1264 may be configured to receive a video file in the form of streaming content in some examples. Media application program 1262 and/or browser application program 1264 may be configured to apply a codec to an encoded video file to obtain a decoded video file.

Media management module 1266 may be configured to receive information from and present information at a GUI, such as GUI 1300 of FIG. 3 for managing the creation of a video file having a plurality of video segments. As one example, media management module 1266 may be configured to apply a codec to a group of video segments to obtain an encoded video file containing the group of video segments.

Client device 1220 may include input/output devices 1258. Non-limiting examples of input/output devices 1258 may include a keyboard or keypad, a computer mouse or other suitable controller, a graphical display device, a touch-sensitive graphical display device, a microphone, an audio speaker, an optical camera or sensor, among other suitable input and/or output devices. The GUIs described herein may be presented via a graphical display device, for example.

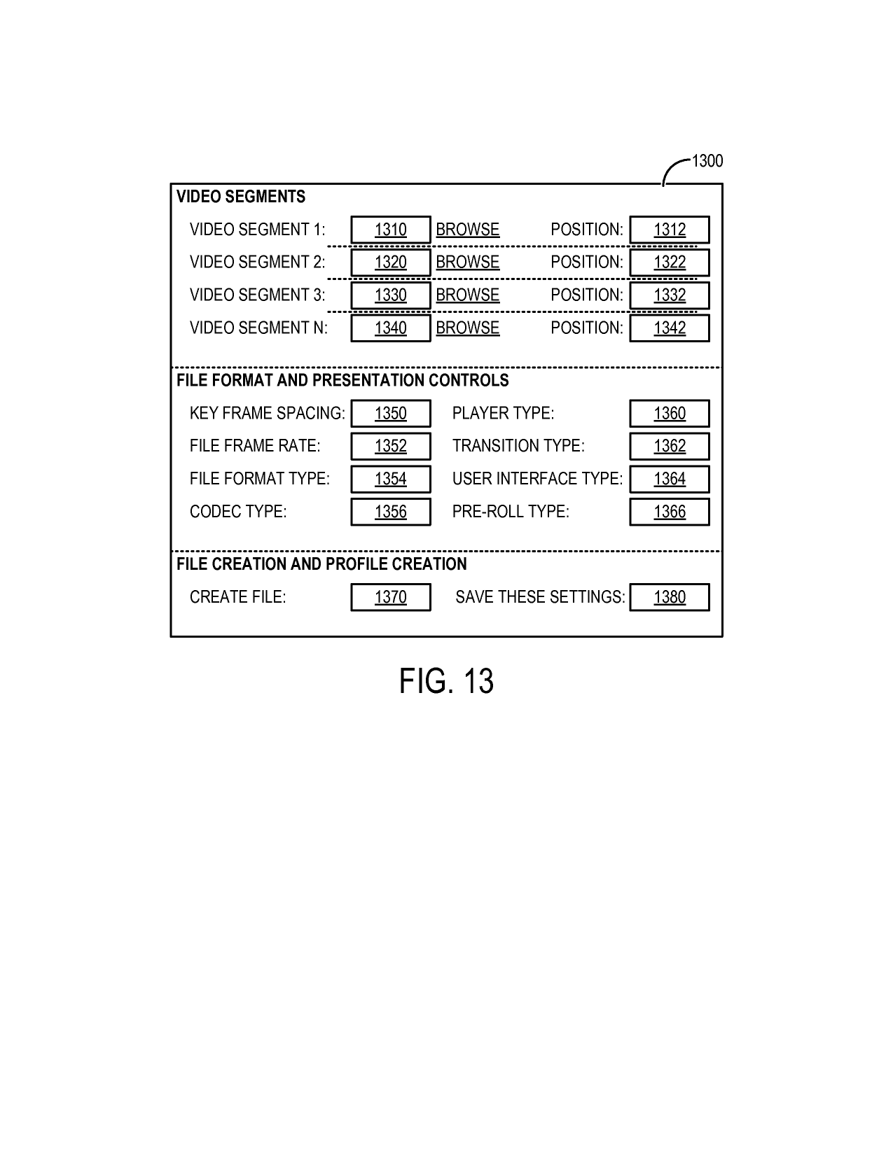

FIG. 13 is a schematic diagram depicting an example graphical user interface (GUI) 1300 for managing the creation of a video file having a plurality of video segments. GUI 1300 may be presented at a computing device or computing system via a graphical display device. GUI 1300 enables a user to define and/or specify each of a plurality of video segments to be combined into a video file. For example, GUI 1300 may include a graphical control element 1310 for loading or uploading a first video segment, a graphical control element 1320 for loading or uploading a second video segment, a graphical control element 1330 for loading or uploading a third video segment, a graphical control element 1340 for loading or uploading a fourth video segment, etc.

GUI 1300 further enables a user to associate each video segment with a respective camera view by defining or specifying a position and/or orientation of each camera or camera view. For example, GUI 1300 may include a number of graphical control elements (e.g., 1312, 1322, 1332, 1342, etc.) for defining or specifying a position and/or orientation of each camera or camera view. The position and/or orientation may be in two-dimensional or three-dimensional space. GUI 1300 may further enable a user to associate audio information (e.g., audio segments) with respective video segments or camera views.

GUI 1300 may further enable a user to specify or define file format and/or presentation control parameters. For example, GUI 1300 may include a plurality of control elements for receiving file format and/or presentation control parameters. These control elements may include or take the form of one or more graphical controls and/or text fields. Non-limiting examples of these control elements include: a control element 1350 for defining a key-frame spacing, a control element 1352 for defining a frame rate of the video file, a control element 1354 for defining a file format type (e.g., .mpeg, .wmv, etc.), a control element 1356 for defining a codec type for encoding and/or decoding the video file, a control element 1360 for defining a media player type (e.g., web-browser embedded media player, special purpose media player, etc.), a control element 1362 for defining a transition type (e.g., to select from one or more of the transitions described herein), a control element 1364 for defining a user interface type (e.g., one or more of the video presentation and control GUIs described herein), and a control element 1366 for defining a pre-roll type (e.g., introduction, advertisement, etc.).

GUI 1300 may further enable a user to create a video file defined by one or more of the predefined parameters set by the user or set on behalf of the user by directing a user input at control element 1370. GUI 1300 may further enable a user to save the settings defined by the user via GUI 1300 to a user profile stored at a storage system or storage device for later implementation.

Some or all of the information depicted in FIG. 13 may be stored as metadata that accompanies the video file. The metadata may form part of the video file or may take the form of a separate file. The metadata may be used by a media or browser application program for presentation of the video file and audio information accompanying the video file. For example, the metadata may indicate the relative position of each video segment, key frame locations and/or spacing, transition type, codec type, etc.

The disclosed embodiments may be used in combination with audio information to provide a multi-media experience. As one example, the video file obtained at 1010 of method 1000 (e.g., by a media application or browser application of a client device) may include one or more audio components or may be accompanied by a separate audio file. If the video file includes one or more audio components, these audio components may take the form of a plurality of audio segments each corresponding to a respective video segment of the video file, or these audio components may take the form of a combination audio segment of the two or more audio segments.

A combined audio segment that forms a component of the video file or a separate audio file that accompanies the video file may be created or otherwise obtained by application of method 1100. As one example, a plurality of audio segments may be obtained at 1110 of method 1000. The plurality of audio segments may each correspond to a respective video segment of the video file (e.g., as different camera views). At 1112 of method 1100, the plurality of audio segments may be combined to obtain either a combination audio segment that forms an audio component of the video file, or a separate audio file that may accompany the video file.

Audio segments corresponding to respective video segments of the video file may be combined in any suitable manner. As one example, the combination of audio segments may be performed at the server system by the server based media management module at the time of video file creation. As another example, the combination of audio segments may be performed at the client device by the client device based media management module at the time of video file creation, or by the media or browser application program at the client device at the time of playback or presentation of the video file and associated audio information.

As one example, an audio file may be created that includes each of the audio segments corresponding to the video segments of the video file. The media management module at the server system or client device may be responsible for creation of the audio file or combination audio segment. Alternatively or additionally, the browser or media application program at the client device may be configured to select one or more of the audio segments from the audio file for presentation at the time of playback of the video file. The one or more audio segments that are selected may correspond to the particular video segment (e.g., camera view) that is being played by the media or browser application program. As another example, some or all of the audio segments may be mixed into a single multi-channel audio segment or file.

In at least some implementations, method 1100 may further include generating metadata that creates an association between the video file and the separate audio file. The metadata may be included as part of the video file and/or the audio file, or may take the form of a separate metadata file. As previously described with reference to FIG. 13, audio segments just as video segments may be assigned or associated with position information to enable audio segments to be distinguished from each other and/or associated with the corresponding video segments. This position information may be stored in or otherwise indicated by the metadata forming part of the video file, a separate audio file, or as a separate metadata file.

Accordingly, one or more of the following audio/video combinations may be supported by the media management module, media application program, and/or browser application programs disclosed herein: (1) a video file that includes a combination audio segment, (2) a video file that includes a plurality of audio segments that may be individually selected for playback, (3) an audio file and a separate video file that includes metadata associating the video file with the audio file, (4) a video file and a separate audio file that includes metadata associating the audio file with the video file, (5) a video file, a separate audio file, and a separate metadata file that associates the video file with the audio file, or (6) combinations thereof.

Presentation of audio information may take various forms, including static audio or dynamically changing audio responsive to the selected video segment (e.g., camera view). As an example of dynamically changing audio, a single audio segment may be presented at a given time in which the single audio segment may correspond to the selected video segment of the current playback position of the video file. As another example of dynamically changing audio, a plurality of audio segments may be presented at a given time in which the plurality of audio segments may take the form of a multi-channel audio presentation providing stereo audio (e.g., 2 channel) or multi-channel (e.g., 3, 4, 5, 6 or more channel) surround sound. Here, the selection of audio segments and/or the relative mix of the audio segments may correspond to the selected video segment of the current playback position of the video file. The selection of audio segments and/or relative mix of audio segments may change as the user navigates to a different camera view. As an example of static audio, the same audio segment or combination (e.g., stereo or multi-channel surround sound) of audio segments may be presented for some (e.g., two or more different camera views) or all of the video segments of the video file. In at least some implementations, the audio file or other suitable combination of audio segments may be of shorter duration (e.g., time length) than the video file. For example, the same audio information (e.g., with the same or different relative mix) may be repeated multiple times across playback of the entire video file among the various video segments. In some implementations, the video file may include or may be accompanied by multiple audio files. For example, a shorter audio file (e.g., lopped for each video segment) may include audio information corresponding to the video segments of the video file, and a longer audio file that includes voice-over audio information that is played over the length of the video file across multiple video segments.

The disclosed embodiments may be used in combination with three-dimensional (3-D video) to enable a user to change perspective relative to a subject. For example, video segments obtained from two or more cameras may be combined to obtain a 3-D video segment. The video file disclosed herein may include a plurality of 3-D video segments, where each 3-D video segment is formed from a different combination of camera views. In some implementations, this combination of camera views for obtaining a 3-D view of the subject may be performed by pre-processing the video segments prior to or at the time of creation of the video file (e.g., at method 1112 of FIG. 11). For example, media management module 1260 or 1266 may be configured to generate 3-D video segments by combining two or more camera views. In other implementations, a 3-D view may be created at the time of playback of the video file (e.g., on the fly) by playing two or more video segments of the video file at the same time, and by presenting these two or more video segments via a common display region in an overlapping manner. For example, media application program 1262 or browser application program 1264 may be configured to create a 3-D view by playing select camera views of the video file at the same time via a graphical display. The particular video segments that are combined to obtain a 3-D video segment or that are played at the same time to provide a 3-D view may be based on the relative position of the cameras (e.g., as defined by a user or some other indicator). For example, video segments obtained from cameras neighboring a camera providing the primary 2-D camera view may be combined with the video segment corresponding to the 2-D camera view to obtain the 3-D video segment. However, it will be appreciated that other suitable techniques for creating 3-D video segments or 3-D views may be used.

While many of the disclosed embodiments were presented in the context of video segments of a common temporal event and/or subject, it will be understood that these video segments may be associated with different temporal events and/or subjects. As one example, the video segments may take the form of advertisements having related or unrelated content. The techniques described herein may similarly enable users to create video files and/or navigate among a plurality of different video segments of the video file, including advertisements or other video content.

It should be understood that the embodiments disclosed herein are illustrative and not restrictive, since the scope of the invention is defined by the following claims rather than by the description preceding them. All changes that fall within metes and bounds of the claims or equivalence of such metes and bounds thereof are therefore intended to be embraced by the claims.

1. A method for a computing device, comprising:
obtaining a video file having a plurality of video segments, each video segment corresponding to a different camera view of a common temporal event;
initiating playback of the video file within a first video segment corresponding to a first camera view of the common temporal event;
responsive to a user input command, changing a playback position of the video file from a current frame number of the first video segment to a destination frame number of a second video segment of the video file, the destination frame number having a predefined relationship to the current frame number; and
continuing playback of the video file from the destination frame number within the second video segment corresponding to a second camera view of the common temporal event to provide a different perspective of a subject captured in the plurality of video segments.

2. The method of claim 1, wherein at least some of the video segments of the video file, including at least the first video segment and the second video segment, have an equal number of frames.

3. The method of claim 1, wherein the predefined relationship defines the same frame number relative to a beginning frame of each video segment.

4. The method of claim 1, wherein the predefined relationship of the destination frame number to the current frame number defines the destination frame number as being immediately subsequent to a frame number of the second video segment that is in time registration with the current frame number of the first video segment with respect to the common temporal event.

5. The method of claim 1, wherein the plurality of video segments includes at least four video segments corresponding to at least four different camera views; and
wherein each of the four different camera views are spaced apart from one or more of the other different camera views at substantially equal intervals relative to the subject captured in the plurality of video segments.

6. The method of claim 1, wherein each video segment includes a plurality of key-frames spaced apart and separated by one or more other frames of that video segment;
wherein each key-frame of the first video segment is in time registration with at least one corresponding key-frame of the second video segment with respect to the common temporal event.

7. The method of claim 6, further comprising:
delaying changing the playback position of the video file and continuing playback of the video file within the first video segment until the current frame reaches a frame having a predefined position relative to a key-frame of the first video segment.

8. The method of claim 7, wherein the frame having the predefined position relative to the key-frame of the first video segment is defined as the key-frame or a frame preceding the key-frame.

9. The method of claim 1, further comprising:
responsive to another user input command, changing a playback position of the video file from a current frame number of the second video segment to a destination frame number of a third video segment, the destination frame number of the third video segment having a predefined relationship to the current frame number of the second video segment; and
continuing playback of the video file from the destination frame number within the third video segment corresponding to a third camera view of the common temporal event.

10. The method of claim 9, wherein the first camera view is positioned closer to the second camera view than the third camera view; and/or
wherein the second camera view is positioned between the first camera view and the third camera view along an arc having a focal point that includes the subject captured in the plurality of video segments.

11. The method of claim 1, wherein the video file includes a third video segment corresponding to a third camera view, the first camera view positioned closer to the third camera view than the second camera view;
wherein the third video segment is located between the first video segment and the second video segment within the video file; and
wherein changing the playback position of the video file from the current frame number of the first video segment to the destination frame number of the second video segment further includes:
continuing playback of the video file from a frame number within the third video segment as a transitional frame number for continuing playback of the destination frame number within the second video segment.

12. The method of claim 11, wherein the transitional frame number has a predefined relationship to the current frame number of the first video segment.

13. The method of claim 12, wherein the predefined relationship of the transitional frame number to the current frame number defines:
the same frame number as the current frame number relative to a beginning frame of each video segment, or
the transitional frame number as a frame number of the third video segment subsequent in time to the current frame number of the first video segment, and preceding in time the destination frame number of the second video segment.

14. The method of claim 1, further comprising:
obtaining the plurality of video segments as separate component video files; and
combining the plurality of video segments to obtain the video file.

15. The method of claim 1, wherein the computing device includes a server system; and
wherein initiating playback of the video file and continuing playback of the video file includes transmitting video content information from the server system via a communications network to a client computing device for presentation.

16. The method of claim 1, wherein the predefined relationship of the destination frame number to the current frame number defines the destination frame number as being immediately subsequent to a frame number of the second video segment that is offset in time registration with the current frame number of the first video segment with respect to the common temporal event.

17. An article, comprising:
a computer readable storage media holding instructions executable by a processor to:
generate a graphical user interface for presentation via a graphical display device, the graphical user interface including:
a video presentation region to present visual aspects of a video file, the video file having a plurality of video segments, each video segment corresponding to a different camera view of a common temporal event;
a control element to enable a user to vary a camera view of the video file among two or more available camera views of the plurality of video segments; and
a video file progress bar indicating a current playback position of the video file within a selected video segment, the video file progress bar representing a duration of the selected video segment, the current playback position of the selected video segment common to two or more of the video segments of the video file as the camera view is varied; and
responsive to a user input command, change a playback position of the video file from a current frame number of a first video segment to a destination frame number of a second video segment of the video file, the destination frame number having a predefined relationship to the current frame number.

18. The article of claim 17, wherein the instructions are further executable by the processor to:
delay changing the playback position of the video file until the current frame reaches a frame having a predefined position relative to a key-frame of the first video segment;
wherein each video segment includes a plurality of key-frames spaced apart and separated by one or more other frames of that video segment, wherein each key-frame of the first video segment is in time registration with at least one corresponding key-frame of the second video segment with respect to the common temporal event.

19. A computing device, comprising:
a processor to execute instructions; and
a storage system holding instructions executable by the processor to:
obtain a plurality of video segments, each video segment corresponding to a different camera view of a common temporal event;
combine the plurality of video segments to obtain a video file by inserting a plurality of key-frames into each of the plurality of video segments, the key-frames spaced apart and separated by one or more other frames of that video segment, wherein each key-frame of a first video segment is in time registration with at least one corresponding key-frame of a second video segment of the plurality of video segments with respect to the common temporal event; and
store the video file including the plurality of video segments at the storage system or at another storage system.

20. The computing device of claim 19, wherein the instructions are further executable by the processor to:
obtain a plurality of camera location indicators, each camera location indicator defining a camera location corresponding to a respective video segment of the plurality of video segments; and
combine the plurality of video segments by ordering the plurality of video segments within the video file based, at least in part, on the relative positioning of the camera locations indicated by the plurality of camera location indicators.
